(19) United States
(12) Patent Application Publication
(10) Pub. No.: US 2003/0083929 A1
(43) Pub. Date: May 1, 2003

(54) METHOD AND APPARATUS FOR TRACKING BANNER ADVERTISING

(75) Inventors: DAVID S. SPRINGER, AUSTIN, TX (US); BRIAN T. ZUCKER, AUSTIN, TX (US)

Correspondence Address: DAVID L MCCOMBS, HAYNES & BOONE LLP, 901 MAIN STREET, SUITE 3100, DALLAS, TX, 75202-3789, US

(73) Assignee: HAYNES & BOONE LLP

(21) Appl. No.: 09/313,436

(22) Filed: May 17, 1999

(51) Int. Cl. G06F 17/60

(52) U.S. Cl. 705/14

(57) ABSTRACT

A method and computer system is provided that allows a computer user to benefit from viewing banner advertising. One embodiment provides a method for allowing a computer user to benefit from viewing banner advertising by providing incentives for information transmitted to and from a computer server. The method also provides for tracking information provided to a computer user from a server, providing an identifier for a computer system associated with the computer user, the identifier identifying the computer system, providing at least one database associating the identifier with the computer user and information specific to the computer user, transmitting the identifier to the server, the server affiliated with the at least one database, transmitting the information to the computer system that is specific to the identifier, and logging the transmittal of the identifier in one of the at least one database. Another embodiment includes a computer system with a processor, a memory device coupled to the processor, and an identifier for a computer system associated with a computer user, the identifier identifying the computer system, the identifier capable of being transmitted to a server, the server affiliated with at least one database that associates the identifier with the computer user and information specific to the computer user, the server tracking the transmittal of the identifier.

### CROSS-REFERENCE TO RELATED APPLICATION

This application relates to co-pending U.S. patent Application Ser. No. ______ filed on Oct. 9, 1998 entitled System and Method for Identification and Streamlined Access to Online Services, naming David S. Springer as inventor. The co-pending application is incorporated herein by reference in its entirety, and is assigned to the assignee of this invention.

### BACKGROUND OF THE INVENTION

1. Field of the Invention

The present invention relates generally to computer systems and more particularly to a method, computer system and apparatus for tracking banner advertising.

2. Description of the Related Art

Personal computer systems have attained widespread use. A personal computer system, such as a DELL® personal computer system, can usually be defined as a desktop or portable microcomputer that includes a system unit having a system processor or central processing unit (CPU) with associated memory, a display panel, a keyboard, a hard disk storage device or other type of storage media such as a floppy disk drive or a compact disk read only memory (CD ROM) drive. These personal computer systems are information handling systems which are designed primarily to give independent computing power to a single user or group of users.

Many computer users purchase computer systems that provide means to access the internet or so-called “worldwide web”. The worldwide web provides useful information to many computer users as well as banner advertising that is displayed on a computer users' computer screen. Generally, banner advertising is provided from a web server to a computer user. The particular advertising that is provided to the computer user is paid for by a party to a party associated with providing the advertising. The computer user that sees the banner advertising does not participate in any revenue associated with the banner advertising. What is needed is a method and computer system that allow a computer user to receive a benefit from viewing banner advertising.

### SUMMARY OF THE INVENTION

A method and computer system is provided that allows a computer user to benefit from viewing banner advertising. One embodiment provides a method for allowing a computer user to benefit from viewing banner advertising by providing incentives for information transmitted to and from a computer server. The method also provides for tracking information provided to a computer user from a server, providing an identifier for a computer system associated with the computer user, the identifier identifying the computer system, providing at least one database associating the identifier with the computer user and information specific to the computer user, transmitting the identifier to the server, the server affiliated with the at least one database, transmitting the information to the computer system that is specific to the identifier, and logging the transmittal of the identifier in one of the at least one database.

Another embodiment includes a computer system with a processor, a memory device coupled to the processor, and an identifier for a computer system associated with a computer user, the identifier identifying the computer system, the identifier capable of being transmitted to a server, the server affiliated with at least one database that associates the identifier with the computer user and information specific to the computer user, the server tracking the transmittal of the identifier.

Another embodiment includes a system for tracking information transmitted by and to a computer user, the system including means for providing an identifier for a computer system associated with the computer user, the identifier identifying the computer system, at least one database associating the identifier with the computer user and information specific to the computer user, means for transmitting the identifier to a server, the server affiliated with the at least one database, means for transmitting the information to the computer system that is specific to the identifier, and means for logging the transmittal of the identifier in one of the at least one database.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a personal computer system in accordance with an embodiment of the present invention.

FIG. 2, labeled “prior art”, is a flow diagram illustrating a known method of providing banner advertising on the worldwide web.

FIG. 3 is a flow diagram illustrating a method of tracking and providing banner advertising and other information on the worldwide web according to an embodiment of the present invention.

FIG. 4 is a flow diagram illustrating a method of providing and tracking banner advertising and other information in accordance with an embodiment of the present invention.

FIG. 5 is flow chart illustrating a method of automatically tracking banner advertising supplied to a computer user.

FIG. 6 is a flow diagram illustrating an alternate method of providing and tracking banner advertising and other information in accordance with an embodiment of the present invention.

The use of the same reference symbols in different drawings indicates similar or identical items.

### DETAILED DESCRIPTION

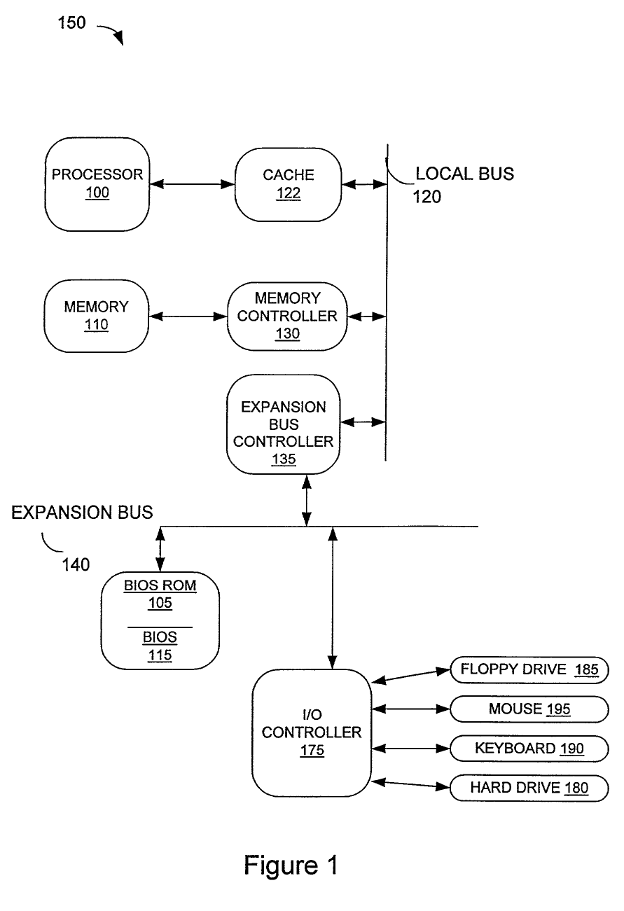

Referring now to FIG. 1, a computer system 150 is shown consistent with an embodiment of the present invention that includes a processor 100, and a memory 110 coupled to the processor 100 via local bus 120.

Local bus 120 includes conventional data, address and control lines conforming to a standard external high speed microprocessor bus. Main system memory 110 may include dynamic random access memory (DRAM) modules coupled to local bus 120 by a memory controller 130. Main memory 110 stores application programs and data for execution by processor 100.

Basic Input/Output System (BIOS) software 115 is stored in nonvolatile memory BIOS ROM 105. BIOS 115 is a microcode software interface between an operating system or application programs and the hardware of computer system 150. The operating system and application programs access BIOS 115 rather than directly manipulating I/O ports and control words of the specific hardware. BIOS 115 is accessed through an interface of software interrupts and contains a plurality of entry points corresponding to the different interrupts. In operation, BIOS 115 is loaded from BIOS ROM 105 to memory 110 and is executed from memory 110.

A bus interface controller or expansion bus controller 135 couples local bus 120 to an expansion bus 140, thereby coupling both the memory 110 and processor 100 to expansion bus 140. Expansion bus 140 is coupled to I/O controller 175 which is coupled to and controls the operation of output media and devices, including hard drive 180, floppy drive 185, keyboard 190 and mouse 195. Additionally, I/O controller 175 operates to control data transfer on the expansion bus 140.

In accordance with an embodiment of the present invention, the hard drive 180 of computer system 100 holds applications specific to the computer user, and optionally, specific to the computer system. In one embodiment, the applications are installed on the hard drive 180, or in firmware, for example, BIOS ROM 105. In another example, a web page includes a software application program can install information on the hard drive 180 associated with the application.

The application program serves multiple purposes. The purposes include requesting an advertisement by transmitting a key identifier and possibly displaying the advertisement on the computer system. Alternatively, the application program disables the transmittal of advertisements, or provides information to a database concerning the types of advertisements a computer user desires to receive or, conversely, desires to avoid receiving.

Alternatively, if a computer system does not contain a unique key identifier associated with a database, the application program installs a unique key identifier corresponding to the computer user in the hard drive 180. Optionally, the computer system 100 already has a unique key identifier installed, which is transmitted when a computer user requests access to a server. For example the unique key identifier could be a unique ID from a microprocessor, a system code, a system code stored in nonvolatile memory or a unique code stored in a peripheral. Additionally, the software application program transmits the information from the computer user to a database, discussed in further detail below.

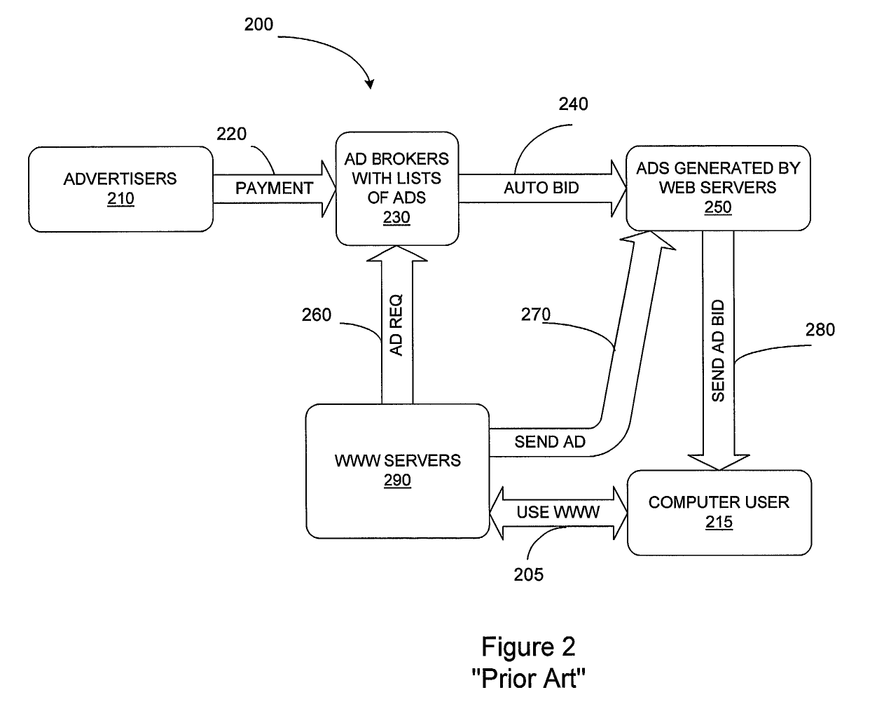

Referring now to FIG. 2, labeled “prior art”, a flow chart 200 illustrates a method showing how advertisements typically reach computer user 215 via the worldwide web. Advertisers 210 pay advertisement brokers AD BROKERS 230 to place banner advertisements on the worldwide web. Advertisement brokers 230 also receive advertisement requests AD REQ 260 from worldwide web servers WWW SERVERS 290 when a worldwide web server needs an advertisement for a computer user 215.

The advertisement brokers receive many ads from a plurality of advertisers. Therefore, an automatic bidding system 240 determines which advertisements of the lists of advertisements 230 should sent to a given computer user 215. Additionally, the automatic bidding system determines when an advertisement should be transmitted. When an advertisement is bid upon and chosen, the advertisement is sent in step 280 to the computer user 215.

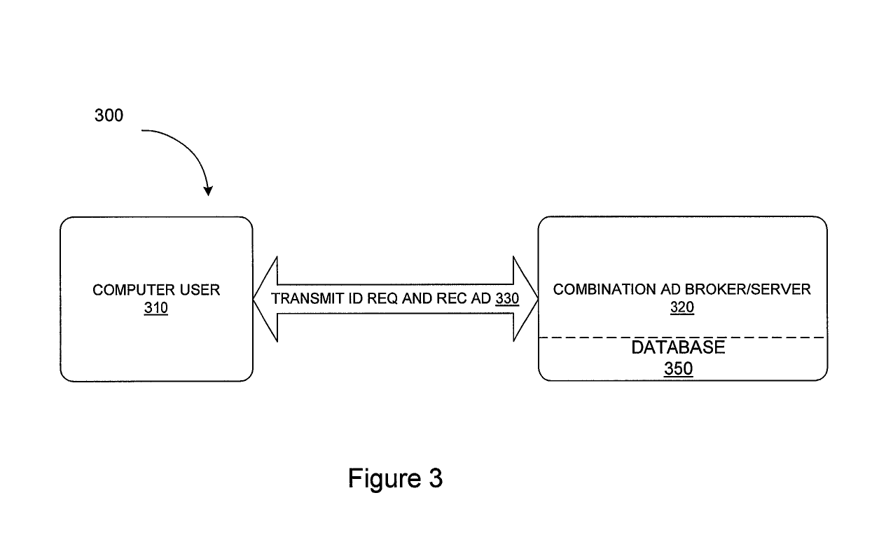

Referring now to FIGS. 3, a simplified flow chart illustrates an embodiment of the present invention. FIG. 3 shows a method 300 for a computer user 310 to receive advertisements from a combination advertisement broker and server 320, which is optionally a web server. As shown, the computer user 310 transmits a unique key identification requesting an advertisement 330. In response, the combination advertisement broker and server 320 transmits an advertisement.

Instead of using a bidding procedure as described above relative to FIG. 2, the combination advertisement broker and server uses a procedure using database 350 to determine the advertisement that should be transmitted to the computer user 310. The database 350 keeps track of which advertisement to transmit to particular computer users 310. Additionally, database 350 keeps track of the number of times the database transmitted advertisements to a particular unique key identifier associated with a particular computer user 310.

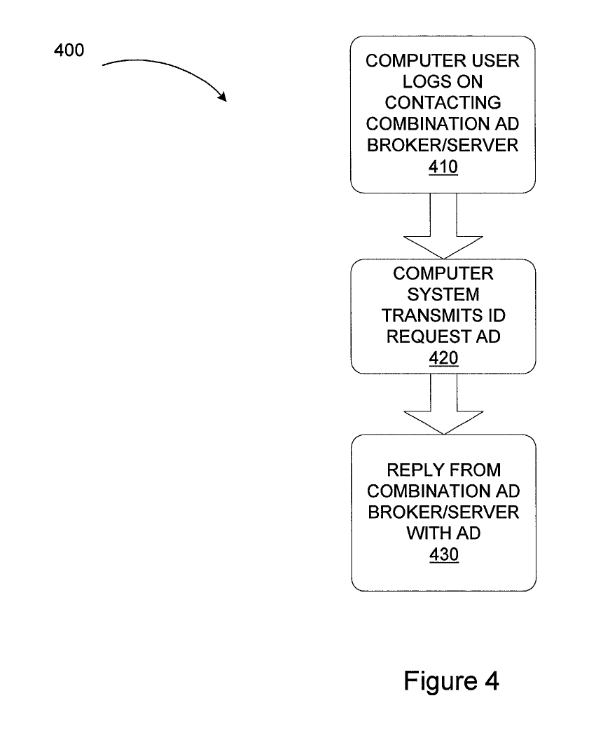

Referring now to FIG. 3 and FIG. 4 in combination, a flow chart describes the transmission and request of advertisements in accordance with an embodiment of the present invention. FIG. 4 illustrates an embodiment in which a computer user 310 logs on to a combination advertisement broker/server 320 by logging on 410. Next at step 420, the computer system transmits a unique identifier and requests a banner advertisement to be displayed on the computer user 310 computer system 100. The combination advertisement broker/server 320 responds by transmitting an advertisement at step 430.

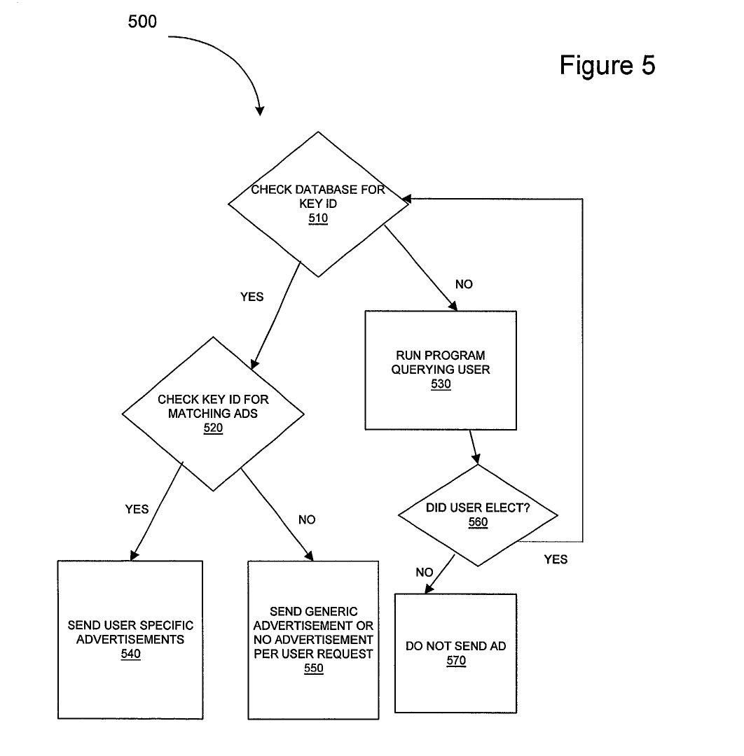

Referring now to FIG. 5 in combination with FIGS. 3 and 4, a method 500 describes tracking banner advertising displayed to computer user 310. After computer user 410 logs onto a server/advertisement broker 320, step 510 provides that the database 350 check for a unique key identifier. If a unique key identifier is discovered, step 520 provides that a counter associated with the server/advertisement broker 320 account for the presence of the unique key identifier. For example, a counter counting the number of times the database located a unique key identifier optionally increases by one. The number of times the database locates a particular unique key identifier optionally determines which advertisements to transmit to the computer user. Additionally, the number of times a database locates a particular unique key identifier optionally provides a tracking mechanism for pricing of advertisements and for provides a mechanism for determining bonus incentives to computer users associated with unique key identifiers. For example, a particular unique key identifier that receives a predetermined number of advertisements on a monthly basis optionally receives discounts on computer components from the combination server/advertisement broker.

Another function of step 520 is to have a database search and locate advertisements that match the criteria provided by the computer user during the querying procedure. The unique key identifier optionally provides an address location in a memory within the database locating information providing during querying of the computer user. This information provides a plurality of parameters for choosing appropriate advertisements for transmittal to the computer user in step 540. If no matching criteria is found in step 520, step 550 provides that either the database transmit generic advertisements that are not specific to the computer user, or that the database transmit no advertisements at all. For example, the querying procedure optionally provides that the computer user choose whether or not to receive banner advertising. If the computer user chooses to avoid advertisements, the database reflects this choice and does not transmit advertisements.

If at step 510 no unique key identifier is found, step 530 provides that the database initialize the software application program discussed above. The software application program then optionally queries the computer user to determine whether the computer user chooses to elect to receive banner advertisements and other information. In this regard the software application program optionally offers incentives encouraging the computer user to participate in receiving banner advertising and/or other information, including bonuses and discounts on a plurality of goods. Step 570 provides that the database decline from sending banner advertisements to the computer user should the computer user choose not to participate. Optionally, step 570 could also provide that if a computer user chooses not to participate, the database send other types of informational banners other than banner advertisements. For example, the database could be coupled to information centers that provide news flashes, stock exchange information, weather reports, or election results.

Step 560 could also provide that a computer user elect to receive informational banners in conjunction with banner advertisements. In this regard, a computer user could receive bonus rewards related to the informational banners chosen.

If at step 560 the computer user elects to receive banner advertisements, or informational banners in conjunction with banner advertisements, step 560 provides that the database store the unique key identifier, then return to step 510, where the method provides for a search of the database for a unique key identifier.

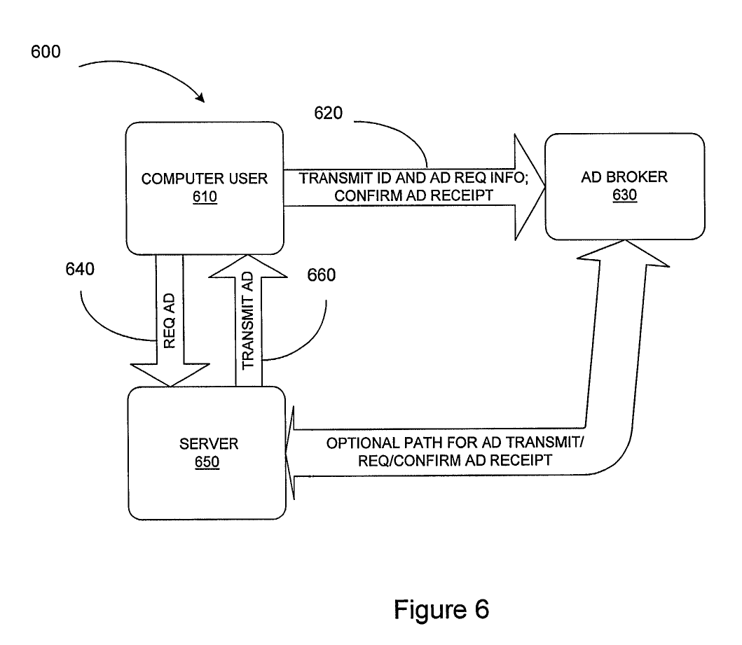

FIG. 6 represents another method 600 for tracking banner advertisements and other information. Unlike the method described in FIG. 3, FIG. 6 shows a method wherein the server 650 and the advertisement broker 630 are not the same. Accordingly, instead of a combination advertisement broker and server transmitting advertisements, the server 650 receives a request for an advertisement 640 from a computer user 610 and the server 650 then transmits an advertisement 660. Simultaneously, the identifier discussed above is transmitted in step 620 to the advertisement broker 630. As in the above-described embodiments, the advertisement broker 630 logs the transmittal of the identifier in a database, thereby tracking the banner advertisements. The server 650 transmits an advertisement or other information to the computer user 610 using either information stored in the hard drive 180 of the computer user 610, or using information stored in a database associated with either the server 650 or the advertisement broker 630. After receiving the information or advertisements, the computer system of the computer user 610 transmits a confirmation of advertisement or information receipt 620 to the advertisement broker 630.

The method 600 of providing a separate advertisement broker 630 advantageously allows revenue sharing among other entities for transmittal of advertisements and information to a computer user 610. For example, advertisements and information specific to a computer user 610 could be brokered through alternate sources allowing more diverse advertisements and information to be transmitted to the computer user 610. Additionally, the method 600 advantageously allows bifurcation of advertisements, i.e., some advertisements could be bid upon in accordance with the prior art method of FIG. 2, and other advertisements could forgo the bidding procedure by having the server 650 transmit other advertisements and information to the computer user 610 outside of the bidding procedure.

Although particular embodiments of the present invention have been shown and described, it will be obvious to those skilled in the art that, based upon the teachings herein, changes and modifications may be made without departing from the embodiments of this invention and its broader aspects. Therefore, the appended claims are to encompass within their scope all such changes and modifications as are within the true spirit and scope of this invention. Furthermore, it is to be understood that the invention is solely defined by the appended claims. It will be understood by those within the art that if a specific number of an introduced claim element is intended, such an intent will be explicitly recited in the claim and, in the absence of such recitation, no such limitation is present. For a non-limiting example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when same claim includes the introductory phrases “one or more” or “at least one” and indefinite articles such as “a” or “an”; the same holds true for the use of definite articles used to introduce claim elements.

What is claimed is:

1. A method of tracking information provided to a computer system from a server, the method comprising:
providing an identifier identifying the computer system;
providing at least one database associating the identifier with information specific to a computer user associated with the computer system;
transmitting the identifier to the server, the server affiliated with the at least one database;
transmitting the information to the computer system that is specific to the identifier; and
logging the transmittal of the identifier in one of the at least one database.

2. The method of claim 1 wherein the logging the transmitting of the identifier further includes:
incrementing a counter associated with the identifier.

3. The method of claim 1 further comprising:
providing that the information transmitted to the computer system includes at least one of advertisements, informational data, advertisements specific to the computer user, and informational data specific to the computer user.

4. The method of claim 1 further comprising:
providing that the server is one of an advertisement broker, a server hosting advertisements, and a server hosting advertisements and in formational data.

5. The method of claim 1 further comprising:
providing an application program;
if the computer system does not contain a preexisting identifier associated with the at least one database, querying the computer user as to information specific to the computer user; and
storing the information in one of the at least one database.

6. The method of claim 1 wherein the transmitting the identifier includes:
requesting access to the server by the computer user via the worldwide web; and
transmitting the identifier when the computer user requests access from the server.

7. The method of claim 1 further comprising:
when the server receives an identifier, checking the at least one database for the identifier;
if the identifier is not found, querying the computer user as to whether the computer user desires to participate in receiving the information from the server;
if the computer user desires to participate, building one of the at least one databases that associates the identifier with the computer user;
if the identifier is found in the at least one database, searching for matching information unique for the identifier and for the computer user;
if matching information is found, transmitting the information unique for the identifier and for the computer user to the computer user from the server;
if no matching information is found, transmitting one of generic information and no information; and
logging the transmittal of the identifier in one of the at least one database.

8. The method of claim 1 wherein the identifier is one of a system code, a system code stored in nonvolatile memory, a unique ID from a microprocessor, a unique ID from a peripheral device and a unique identifier stored on a hard drive.

9. The method of claim 1 wherein the information unique to the computer user includes one of incentives, bonuses and discounts on a plurality of goods.

10. A computer system comprising:
a processor;
a memory device coupled to the processor;
an identifier for a computer system associated with a computer user, the identifier identifying the computer system, the identifier capable of being transmitted to a server, the server affiliated with at least one database that associates the identifier with the computer user and information specific to the computer user, the server tracking the transmittal of the identifier.

11. The computer system of claim 10, further comprising:
an application program that queries the computer user to obtain data for associating information specific to the computer user for transmittal, the application program storing the data in the at least one database and associating the identifier with the data.

12. The computer system of claim 10 wherein the server is accessible to the computer user via the worldwide web.

13. The computer system of claim 10 wherein the information specific to the computer user includes at least one of advertisements, informational data, advertisements specific to the computer user, and informational data specific to the computer user.

14. The computer system of claim 10 wherein the server increments a counter each time the identifier is received by the server.

15. The computer system of claim 10 wherein the database is affiliated with an advertisement broker that is also affiliated with the server, the advertisement broker receiving the identifier and logging the transmittal of the identifier in a database to track the transmittal of information specific to the computer user.

16. The computer system of claim 10 wherein the identifier is one of a system code, a system code stored in nonvolatile memory, a unique ID from a microprocessor, a unique ID from a peripheral device and a unique identifier stored on a hard drive.

17. A system for tracking information transmitted by and to a computer user, the system comprising:
means for providing an identifier for a computer system associated with the computer user, the identifier identifying the computer system;
at least one database associating the identifier with the computer user and information specific to the computer user means for transmitting the identifier to a server, the server affiliated with the at least one database;
means for transmitting the information to the computer system that is specific to the identifier; and
means for logging the transmittal of the identifier in one of the at least one database.

18. The system of claim 17 further comprising:
a counter, the counter incrementing upon at least one of the transmittal of the identifier to the server and the transmittal of information to the computer system.

19. The system of claim 17 wherein:
the information transmitted to the computer system includes at least one of advertisements, informational data, advertisements specific to the computer user, and informational data specific to the computer user.

20. The system of claim 17 wherein:
the server is one of an advertisement broker, a server hosting advertisements, and a server hosting advertisements and informational data.

21. The system of claim 17 further comprising:
an application program, the application program querying the computer user as to information specific to the computer user if the computer system does not contain a preexisting identifier associated with the at least one database; and
means for storing the information in one of the at least one database.

22. The system of claim 17 wherein the server is accessible to the computer user via the worldwide web.

23. The system of claim 17 wherein the information specific to the computer user includes at least one of advertisements, informational data, advertisements specific to the computer user, and informational data specific to the computer user.

24. The system of claim 17 wherein the identifier is one of a system code, a system code stored in nonvolatile memory, a unique ID from a microprocessor, a unique ID from a peripheral device and a unique identifier stored on a hard drive.
